(19) United States
(12) Patent Application Publication
(10) Pub. No.: US 2025/0126583 A1
(43) Pub. Date: Apr. 17, 2025

(54) TECHNIQUES FOR TIMING ADVANCE VALIDATION FOR SECONDARY CELL ACTIVATION

(71) Applicant: QUALCOMM Incorporated, San Diego, CA (US)

(72) Inventors: Jing LEI, San Diego, CA (US); Changhwan PARK, San Diego, CA (US)

(21) Appl. No.: 18/486,969

(22) Filed: Oct. 13, 2023

(51) Int. Cl. H04W 56/00; H04W 8/08

(52) U.S. Cl. CPC H04W 56/0045; H04W 8/08

(57) ABSTRACT

Methods, systems, and devices for wireless communications are described. Techniques described herein provide timing advance validation for secondary cell (SCell) activation. Prior to receiving a SCell de-activation message associated with a SCell, a user equipment (UE) may determine a TA value for uplink transmissions to the SCell, and the UE may determine a first signal quality metric associated with wireless communication between the UE and the SCell. The UE may receive the SCell de-activation message, and, at a later time, may receive a SCell activation message. The UE may determine whether the TA value determined prior to receipt of the SCell de-activation message is valid for the wireless communications between the UE and the SCell based on a difference between the first signal quality metric and a second signal quality metric determined after receipt of the SCell activation message.

### FIELD OF TECHNOLOGY

The following relates to wireless communications, including techniques for timing advance validation for secondary cell activation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for timing advance (TA) validation for uplink transmissions associated with secondary cell (SCell) activation in one or multiple timing advance groups. For example, the described techniques provide for validating a TA value obtained prior to receiving a SCell de-activation message. In some examples, prior to receiving the SCell de-activation message associated with the SCell, the UE may determine a TA value for uplink transmissions to the SCell, and the UE may determine a first signal quality metric associated with wireless communication between the UE and the SCell. The UE may receive the SCell de-activation message, and the UE, at a later time, may receive a SCell activation message. The UE may determine a second signal quality metric after receipt of the SCell activation message. The UE may determine whether the TA value determined prior to receipt of the SCell deactivation message is valid for the wireless communications between the UE and the SCell based on a difference between the first signal quality metric and the second signal quality metric.

A method for wireless communication by a UE is described. The method may include receiving a secondary cell de-activation message associated with a secondary cell, the secondary cell de-activation message received after determination by the UE of a timing advance value for an uplink transmission to the secondary cell and after determination of a first signal quality metric associated with wireless communications between the UE and the secondary cell, receiving a secondary cell activation message associated with the secondary cell, and determining, in response to receiving the secondary cell activation message, whether the timing advance value determined prior to receipt of the secondary cell de-activation message is valid for the wireless communications between the UE and the secondary cell after receipt of the secondary cell activation message based on a difference between the first signal quality metric and a second signal quality metric, where the second signal quality metric is determined after receipt of the secondary cell activation message.

A UE for wireless communication is described. The UE may include one or more memories storing processor executable code, and one or more processors coupled with the one or more memories. The one or more processors may individually or collectively operable to execute the code to cause the UE to receive a secondary cell de-activation message associated with a secondary cell, the secondary cell de-activation message received after determination by the UE of a timing advance value for an uplink transmission to the secondary cell and after determination of a first signal quality metric associated with wireless communications between the UE and the secondary cell, receive a secondary cell activation message associated with the secondary cell, and determine, in response to receiving the secondary cell activation message, whether the timing advance value determined prior to receipt of the secondary cell de-activation message is valid for the wireless communications between the UE and the secondary cell after receipt of the secondary cell activation message based on a difference between the first signal quality metric and a second signal quality metric, where the second signal quality metric is determined after receipt of the secondary cell activation message.

Another UE for wireless communication is described. The UE may include means for receiving a secondary cell de-activation message associated with a secondary cell, the secondary cell de-activation message received after determination by the UE of a timing advance value for an uplink transmission to the secondary cell and after determination of a first signal quality metric associated with wireless communications between the UE and the secondary cell, means for receiving a secondary cell activation message associated with the secondary cell, and means for determining, in response to receiving the secondary cell activation message, whether the timing advance value determined prior to receipt of the secondary cell de-activation message is valid for the wireless communications between the UE and the secondary cell after receipt of the secondary cell activation message based on a difference between the first signal quality metric and a second signal quality metric, where the second signal quality metric is determined after receipt of the secondary cell activation message.

A non-transitory computer-readable medium storing code for wireless communication is described. The code may include instructions executable by a processor to receive a secondary cell de-activation message associated with a secondary cell, the secondary cell de-activation message received after determination by the UE of a timing advance value for an uplink transmission to the secondary cell and after determination of a first signal quality metric associated with wireless communications between the UE and the secondary cell, receive a secondary cell activation message associated with the secondary cell, and determine, in response to receiving the secondary cell activation message, whether the timing advance value determined prior to receipt of the secondary cell de-activation message is valid for the wireless communications between the UE and the secondary cell after receipt of the secondary cell activation message based on a difference between the first signal quality metric and a second signal quality metric, where the second signal quality metric is determined after receipt of the secondary cell activation message.

In some examples of the method, UEs, and non-transitory computer-readable medium described herein, determining whether the timing advance value may be valid for the wireless communications between the UE and the secondary cell after receipt of the secondary cell activation message may include operations, features, means, or instructions for determining that the difference between the first signal quality metric and the second signal quality metric may be less than or equal to a threshold, the method further including and reusing the timing advance value based on the difference satisfying the threshold.

Some examples of the method, UEs, and non-transitory computer-readable medium described herein may further include operations, features, means, or instructions for receiving control signaling that indicates the threshold.

Some examples of the method, UEs, and non-transitory computer-readable medium described herein may further include operations, features, means, or instructions for receiving control signaling a first duration of time associated with a determination of the first signal quality metric.

Some examples of the method, UEs, and non-transitory computer-readable medium described herein may further include operations, features, means, or instructions for determining the timing advance value at a first time and determining the first signal quality metric within a first time window based on the first duration and the first time.

In some examples of the method, UEs, and non-transitory computer-readable medium described herein, the first duration may be based in part on a measurement cycle of the secondary cell, a frequency range, a scaling factor or a combination thereof.

Some examples of the method, UEs, and non-transitory computer-readable medium described herein may further include operations, features, means, or instructions for receiving control signaling that indicates a second duration associated with a determination of the second signal quality metric.

Some examples of the method, UEs, and non-transitory computer-readable medium described herein may further include operations, features, means, or instructions for determining the second signal quality metric within a second time window based on the second duration and a time for which validity of the timing advance value may be evaluated.

In some examples of the method, UEs, and non-transitory computer-readable medium described herein, the second duration may be based in part on a measurement cycle of the secondary cell, a frequency range, a scaling factor or a combination thereof.

In some examples of the method, UEs, and non-transitory computer-readable medium described herein, the first signal quality metric may be determined based on a cell defining synchronization signal block, a non-cell defining synchronization signal block, a tracking reference signal or a channel state information reference signal.

In some examples of the method, UEs, and non-transitory computer-readable medium described herein, determining whether the timing advance value may be valid for the wireless communications between the UE and the secondary cell after receipt of the secondary cell activation message may include operations, features, means, or instructions for determining that the difference between the first signal quality metric and the second signal quality metric may be greater than a threshold, the method further includes, suspending an uplink transmission on a first timing advance group (TAG) associated with the secondary cell, discarding the timing advance value associated with the first TAG, and transmitting, to the network entity, first control signaling that requests the network entity to issue an order for a random access procedure to acquire a second timing advance value associated with the first TAG.

In some examples of the method, UEs, and non-transitory computer-readable medium described herein, the control signaling that requests the network entity to issue the order for the random access procedure may be transmitted on an activated primary cell or a second secondary cell associated with a secondary TAG and the second secondary cell may have a valid timing advance value and the method, apparatuses, and non-transitory computer-readable medium may include further operations, features, means, or instructions for receiving second control signaling that indicates the order for the random access procedure and initiating the random access procedure on the activated primary cell or the secondary cell associated with the first TAG.

In some examples of the method, UEs, and non-transitory computer-readable medium described herein, the first signal quality metric and the second signal quality metric may be determined based on a same type of downlink reference signal or a different type of downlink reference signal.

In some examples of the method, UEs, and non-transitory computer-readable medium described herein, the first signal quality metric and the second signal quality metric may be determined on different cells having a same timing advance group as the secondary cell.

In some examples of the method, UEs, and non-transitory computer-readable medium described herein, the secondary cell may be configured with physical uplink control channel resources.

In some examples of the method, UEs, and non-transitory computer-readable medium described herein, the first signal quality metric and the second signal quality metric may be both reference signal received power (RSRP) determinations.

In some examples of the method, UEs, and non-transitory computer-readable medium described herein, the UE may be in a radio resource control (RRC) connected mode during the determination the timing advance value and during the determination of the first signal quality metric.

A method for wireless communication by a network entity is described. The method may include transmitting, to a UE, a first control signaling that indicates a threshold associated with determining that a timing advance value is valid, transmitting, to the UE and after transmission of the first control signaling, a secondary cell de-activation message associated with a secondary cell, and transmitting, to the UE, a secondary cell activation message associated with the secondary cell, where the secondary cell activation message is transmitted prior to a determination that the timing advance value is valid.

A network entity for wireless communication is described. The network entity may include one or more memories storing processor executable code, and one or more processors coupled with the one or more memories. The one or more processors may individually or collectively operable to execute the code to cause the network entity to transmit, to a UE, a first control signaling that indicates a threshold associated with determining that a timing advance value is valid, transmit, to the UE and after transmission of the first control signaling, a secondary cell de-activation message associated with a secondary cell, and transmit, to the UE, a secondary cell activation message associated with the secondary cell, where the secondary cell activation message is transmitted prior to a determination that the timing advance value is valid.

Another network entity for wireless communication is described. The network entity may include means for transmitting, to a UE, a first control signaling that indicates a threshold associated with determining that a timing advance value is valid, means for transmitting, to the UE and after transmission of the first control signaling, a secondary cell de-activation message associated with a secondary cell, and means for transmitting, to the UE, a secondary cell activation message associated with the secondary cell, where the secondary cell activation message is transmitted prior to a determination that the timing advance value is valid.

A non-transitory computer-readable medium storing code for wireless communication is described. The code may include instructions executable by a processor to transmit, to a UE, a first control signaling that indicates a threshold associated with determining that a timing advance value is valid, transmit, to the UE and after transmission of the first control signaling, a secondary cell de-activation message associated with a secondary cell, and transmit, to the UE, a secondary cell activation message associated with the secondary cell, where the secondary cell activation message is transmitted prior to a determination that the timing advance value is valid.

Some examples of the method, network entities, and non-transitory computer-readable medium described herein may further include operations, features, means, or instructions for transmitting, to the UE, control signaling that indicates a first duration of time associated with a determination of a first signal quality metric at the UE, where the determination of the first signal quality metric may be prior to transmission of the secondary cell de-activation message.

In some examples of the method, network entities, and non-transitory computer-readable medium described herein, the first duration may be based in part on a measurement cycle of the secondary cell, a frequency range, a scaling factor or a combination thereof.

Some examples of the method, network entities, and non-transitory computer-readable medium described herein may further include operations, features, means, or instructions for transmitting, to the UE, control signaling that indicates a second duration of time associated with a determination of a second signal quality metric at the UE, where the secondary cell activation message may be transmitted prior to the determination of the second signal quality metric.

In some examples of the method, network entities, and non-transitory computer-readable medium described herein, the second duration may be based in part on a measurement cycle of the secondary cell, a frequency range, a scaling factor or a combination thereof.

In some examples of the method, network entities, and non-transitory computer-readable medium described herein, the secondary cell may be configured with physical uplink control channel resources.

### BRIEF DESCRIPTION OF THE DRAWINGS

FIG. 1 shows an example of a wireless communications system that supports techniques for timing advance validation for secondary cell (SCell) activation in accordance with one or more aspects of the present disclosure, wherein the one or multiple dormant or de-activated SCells are activated by SCell activation message or SCell activation command transmitted via downlink control information, control element of medium access control, radio resource control signaling, or a combination thereof.

FIG. 2 shows an example of a wireless communications system that supports techniques for timing advance validation for uplink transmissions associated with SCell activation in accordance with one or more aspects of the present disclosure, wherein the uplink transmissions include physical uplink shared data channel, physical uplink control channel, reference signals for sensing, positioning, channel sounding, phase tracking and demodulation, or a combination thereof.

FIG. 3 shows an example of a timing diagram that supports techniques for timing advance validation for uplink transmissions associated with SCell activation in accordance with one or more aspects of the present disclosure, wherein the SCell de-activation command and the SCell activation command are transmitted on the primary cell, the secondary cell, or a combination thereof.

FIG. 4 shows an example of a process flow that supports techniques for timing advance validation for SCell activation in accordance with one or more aspects of the present disclosure, wherein the control signaling associated with TA validation, the DL reference signals for measurements, the SCell de-activation message and the SCell activation message are transmitted on the primary cell, the secondary cell, or a combination thereof.

FIGS. 5 and 6 show block diagrams of devices that support techniques for timing advance validation for SCell activation in one or multiple timing advance groups in accordance with one or more aspects of the present disclosure.

FIG. 7 shows a block diagram of a communications manager that supports techniques for timing advance validation for SCell activation in accordance with one or more aspects of the present disclosure, wherein the communication manager is mapped to a primary cell, a secondary cell, or a combination thereof.

FIG. 8 shows a diagram of a system including a device that supports techniques for timing advance validation for SCell activation in accordance with one or more aspects of the present disclosure.

FIGS. 9 and 10 show block diagrams of devices that support techniques for timing advance validation for SCell activation in accordance with one or more aspects of the present disclosure.

FIG. 11 shows a block diagram of a communications manager that supports techniques for timing advance validation for SCell activation in accordance with one or more aspects of the present disclosure.

FIG. 12 shows a diagram of a system including a device that supports techniques for timing advance validation for SCell activation in accordance with one or more aspects of the present disclosure.

FIGS. 13 through 15 show flowcharts illustrating methods that support techniques for timing advance validation for SCell activation in accordance with one or more aspects of the present disclosure.

### DETAILED DESCRIPTION

In some wireless communications systems, a user equipment (UE) may communicate with a network entity via one or more serving cells (e.g., a primary cell (PCell) and a secondary cell (SCell)). The network may activate the SCell at the UE to increase data throughput, to alleviate network congestion, or both. In a SCell activation procedure, the UE may transmit a valid channel state information (CSI) report on a physical uplink control channel (PUCCH), an UL data or control message on a physical uplink shared data channel (PUSCH), and one or multiple uplink reference signals for sensing, positioning, channel sounding, demodulation or phase tracking. If the UE does not have a valid timing advance (TA) value on the SCell that is configured with PUCCH resources associated with the CSI reporting, the UE may perform a random access (RA) procedure to acquire or re-acquire a TA value. Acquiring the TA value may increase latency of the SCell activation procedure and may cause throughput loss due to interruption of data communications incurred during the RA procedure.

Techniques for validating a TA value obtained prior to receiving a SCell de-activation message may reduce the latency and the throughput loss associated with the SCell activation procedure. In some examples, prior to receiving a SCell de-activation message associated with a SCell, the UE may determine a TA value for uplink transmissions to the SCell, and the UE may determine a first signal quality metric associated with wireless communication between the UE and the SCell. The UE may receive the SCell de-activation message, and the UE, at a later time, may receive a SCell activation message. The UE may determine a second signal quality metric after receipt of the SCell activation message. The UE may determine whether the TA value determined prior to receipt of the SCell de-activation message is valid for the wireless communications between the UE and the SCell based on a difference between the first signal quality metric and the second signal quality metric. The UE may determine that the difference between the first signal quality metric and the second signal quality metric is less than or equal to a threshold indicating that the TA value is valid, and the UE may reuse the TA value without performing the RA procedure.

In some examples, the UE may receive, from the network entity, control signaling that indicates the threshold. In some cases, UE may receive, from the network entity, control signaling that indicates a first duration of time associated with a determination of the first signal quality metric. The UE may determine the first signal quality metric within a first time window based on the first duration and a time when the TA value was determined. In some cases, the UE may receive, from the network entity, control signaling that indicates a second duration of time associated with a determination of the second signal quality metric. The UE may determine the second signal quality metric within a second time window based on the second duration and a time for which validity of the TA value is evaluated.

Aspects of the disclosure are initially described in the context of wireless communications systems. Aspects of the disclosure are also described in context of a timing diagram and a process flow. Aspects of the disclosure are further illustrated by and described with reference to apparatus diagrams, system diagrams, and flowcharts that relate to techniques for timing advance validation for SCell activation.

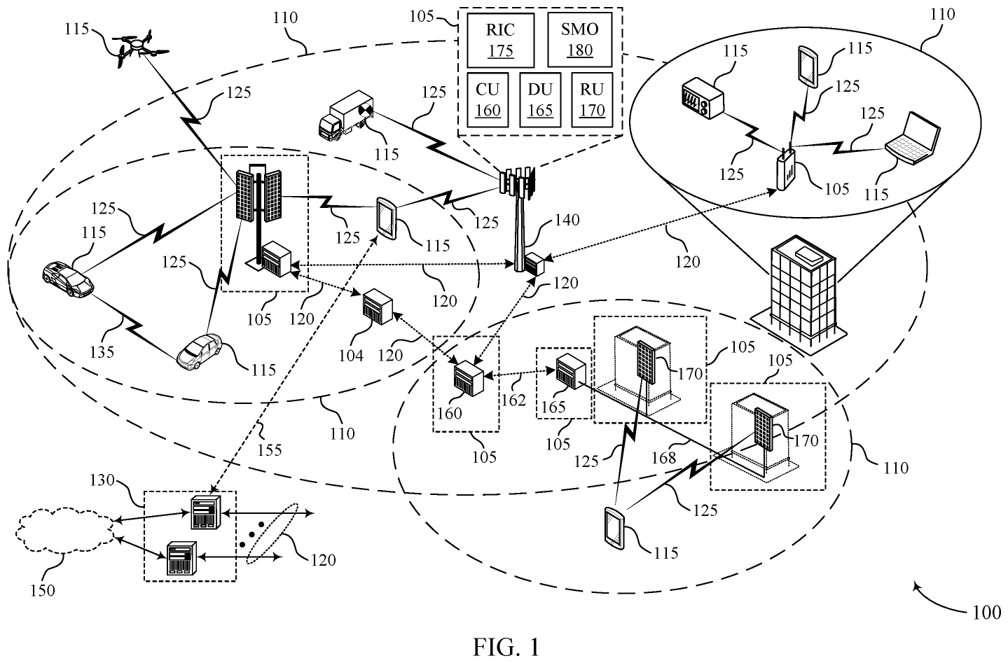

FIG. 1 shows an example of a wireless communications system 100 that supports techniques for timing advance validation for SCell activation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for timing advance validation for SCell activation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5 GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications systems, the UE 115 may communicate with the network entity 105 via one or more serving cells (e.g., a PCell and a SCell). The network may activate the SCell at the UE 115 to increase data throughput, to alleviate network congestion, or both. In a SCell activation procedure, the UE 115 may transmit a valid CSI report on a PUCCH, an UL data or control message on a PUSCH, and one or multiple uplink reference signals for sensing, positioning, channel sounding, demodulation or phase tracking. If the UE 115 does not have a valid TA value on the SCell that is configured with PUCCH resources associated with the CSI reporting, the UE may perform a RA procedure to acquire or re-acquire a TA value. Acquiring the TA value may increase latency of the SCell activation procedure and may cause throughput loss due to interruption of data communications incurred during the RA procedure.

Techniques for validating a TA value obtained prior to receiving a SCell de-activation message may reduce the latency and the throughput loss associated with the SCell activation procedure. In some examples, prior to receiving a SCell de-activation message associated with a SCell, the UE 115 may determine a TA value for uplink transmissions to the SCell, and the UE 115 may determine a first signal quality metric associated with wireless communication between the UE 115 and the SCell. The UE 115 may receive the SCell de-activation message, and the UE 115, at a later time, may receive a SCell activation message. The UE 115 may determine a second signal quality metric after receipt of the SCell activation message. The UE 115 may determine whether the TA value determined prior to receipt of the SCell de-activation message is valid for the wireless communications between the UE 115 and the SCell based on a difference between the first signal quality metric and the second signal quality metric. The UE 115 may determine that the difference between the first signal quality metric and the second signal quality metric is less than or equal to a threshold indicating that the TA value is valid, and the UE 115 may reuse the TA value without performing the RA procedure.

In some examples, the UE 115 may receive, from the network entity 105, control signaling that indicates the threshold. In some cases, UE 115 may receive, from the network entity 105, control signaling that indicates a first duration of time associated with a determination of the first signal quality metric. The UE 115 may determine the first signal quality metric within a first time window based on the first duration and a time when the TA value was determined. In some cases, the UE 115 may receive, from the network entity 105, control signaling that indicates a second duration of time associated with a determination of the second signal quality metric. The UE 115 may determine the second signal quality metric within a second time window based on the second duration and a time for which validity of the TA value is evaluated.

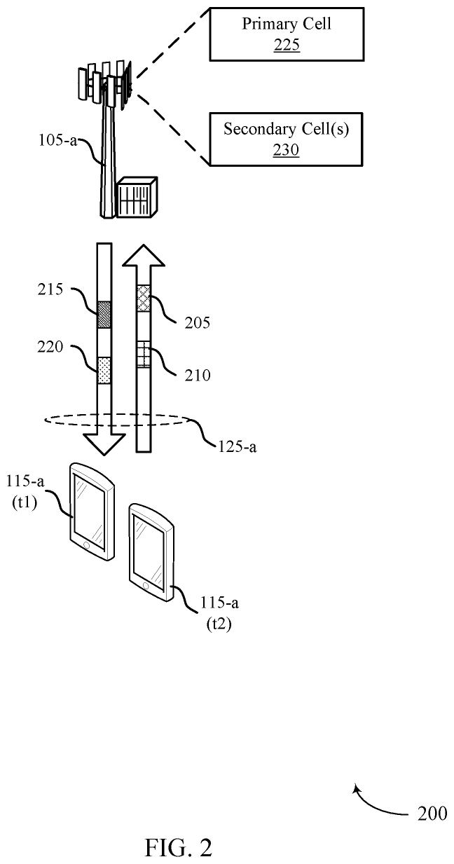

FIG. 2 shows an example of a wireless communications system 200 that supports techniques for TA validation for SCell activation in accordance with one or more aspects of the present disclosure. The wireless communications system 200 may implement aspects of or may be implemented by aspects of the wireless communications system 100. For example, the wireless communications system 200 includes a UE 115-a, which may be an example of a UE 115 as described herein. The wireless communications system 200 may also include a network entity 105-a, which may be an example of a network entity 105 as described herein.

The UE 115-a may communicate with the network entity 105-a using a communication link 125-a. The communication link 125-a may be an example of an NR or LTE link between the UE 115-a and the network entity 105-a. The communication link 125-a may include bi-directional links that enable both uplink and downlink communications. For example, the UE 115-a may transmit uplink signals (e.g., uplink transmissions), such as uplink control signaling 205 and uplink data signals 210, to the network entity 105-a using the communication link 125-a, and the network entity 105-a may transmit downlink signals (e.g., downlink transmissions), such as downlink control signaling 215 and downlink data signals 220, to the UE 115-a using the communication link 125-a.

In some examples, the network entity 105-a may include a PCell 225 and one or more SCells 230. The PCell 225 is a cell, operating on a primary frequency, in which the UE 115-a may perform an initial connection establishment procedure or may initiate a connection re-establishment procedure. The SCell 230 is a cell, operating on a secondary frequency, which may be configured once an RRC connection is established. The UE 115-a may communicate with the network entity 105-a via one or more serving cells (e.g., the PCell 225 and the SCell 230). The network entity 105-a may activate additional serving cells at the UE 115-a to increase data throughput, to alleviate network congestion, or both. In some examples, the network entity 105-a may transmit, to the UE 115-a, a SCell activation message (e.g., control signaling 215) to activate the SCell 230. In some cases, the network entity 105-a may transmit, to the UE 115-a, a SCell de-activation message (e.g., control signaling 215) to de-activate the SCell 230, such as when there is no more data to be delivered to the UE 115-a.

The SCell activation procedure in NR or 5G systems may have an associated delay requirement being a sum of a duration of time for HARQ, a duration of time for activation and a duration of time for channel state information reporting (T_{HARQ}+T_{activation_time}+T_{CSI_Reporting}). In the SCell activation procedure, the UE 115-a may transmit a valid channel state information (CSI) report on a PUCCH, and the UE 115-a may perform actions related to the activation command including time and frequency tracking and automatic gain control (AGC) retuning. If the UE 115-a does not have a valid TA value on the SCell 230 that is configured with PUCCH resources (PUCCH SCell) associated with the CSI reporting, the UE 115-a may perform a random access (RA) procedure to acquire or re-acquire the TA value. Even with an aperiodic tracking reference signal (A-TRS), an amount of time for the TA value acquisition is non-trivial for SCell activation.

In some examples, for the UE 115-a with low mobility, the TA value on the PUCCH SCell may be proportional to the round trip time (RTT) of a signal between the UE 115-a and the network entity 105-a, which will not change much regardless of whether the SCell is activated or de-activate. For example, FIG. 2 illustrates the UE 115-a at a first time (t1) and the UE 115-a at a second time (t2). For example, the UE 115-a may change locations by a small amount of distance or may move a small additional distance away from the network entity 105-a. In the cases where the UE 115-a may stay in the same location or move the small distance, the RTT may not change or may change a small amount. Since the TA value may be proportional to the RTT, the TA value may not change or may change by a small amount when the UE 115-a stays in the same location or moves the small distance. If the TA value determined before the SCell de-activation may be re-used after SCell activation, the latency of the SCell activation procedure and the throughput loss (e.g., interruption of data communications incurred during the RA procedure) may be significantly reduced.

Techniques for TA value validation may include signaling support in the RRC connect state and procedures to determine whether the TA value, obtained prior to the SCell de-activation, is valid for uplink transmissions associated with SCell activation in one or more timing advance groups. The TA value validation may be performed when the UE 115-a is to transmit on uplink of one or multiple SCells, after receiving SCell activation messages for the one or multiple SCells which were de-activated or dormant. The uplink transmissions may include physical uplink shared data channel, physical uplink control channel, reference signals for sensing, positioning, channel sounding, phase tracking and demodulation, or a combination thereof. Validating the TA value may reduce latency, communication interruption time, signaling overhead and power consumption associated with the SCell activation.

In some examples, the UE 115-a performs procedures for TA value validation. After receiving a SCell de-activation message or command (e.g., control signaling 215) for the SCell 230 configured with PUCCH resources, a MAC entity of UE 115-a may store an uplink TA value (N_{TA_last})) that was valid for the last uplink transmission before the UE 115-a received the SCell de-activation message. The SCell de-activation command or message may be transmitted on the PCell 225, the SCell 230, or a combination thereof. The SCell de-activation message may be a sequence-based go to sleep signal, downlink control information (DCI), a control element of medium access control (MAC CE), RRC signaling. The last uplink transmission may be associated with a timing advance group (TAG) of the PUCCH SCell 230. After receiving a SCell de-activation message, the MAC entity of UE 115-a may store a first signal quality metric (e.g., a last signal quality metric (RSRP₁) determined before receiving the SCell de-activation message), such as a reference signal received power (RSRP) measurement, of the downlink pathloss reference signal (RS) before the UE 115-a received the SCell de-activation message. The RSRP measurement may be associated with the timing reference cell of the TAG of the PUCCH SCell 230. The UE 115-a may have measured the RSRP₁ prior to receiving the SCell de-activation message.

In some examples, after receiving a SCell activation message or command (e.g., downlink control signaling 215), the UE 115-a may measure a second signal quality metric (RSRP₂), such as a RSRP measurement of the downlink pathloss RS after the UE 115-a received the SCell activation message. The RSRP₂ may be assumed to be an RSRP measurement of the downlink pathloss RS for TA validation. One or more dormant or de-activated SCells may be activated by the SCell activation message or the SCell activation command transmitted via DCI, a MAC CE, RRC signaling, sequence-based wake up signal, or a combination thereof. The SCell activation message or command may be transmitted on the PCell 225, the SCell 230, or a combination thereof. If the UE 115-a receives activation message(s) for SCell(s) in one or multiple TAGs, the TA value validation procedure may be performed by the UE 115-a for SCell(s) associated with one or more TAGS.

In some examples, the MAC entity of the UE 115-a may consider the TA value N_{TA_last} is a valid TA value for the initial CSI reporting on the PUCCH SCell 230 if the first signal quality metric (RSRP₁) is measured or completed within a first time window, if the second signal quality metric (RSRP₂) is measured or completed within a second time window, and if the difference between the first signal quality metric and a second signal quality metric is less than or equal to a threshold (SCell-RSRP-ChangeThreshold) (e.g., |RSRP₁−RSRP₂|≤SCell-RSRP-ChangeThreshold). In some examples, the network entity 105-a may transmit, to the UE 115-a, control signaling (e.g., control signaling 215) that indicates the threshold. The control signaling may be RRC signaling, downlink control information (DCI) or a MAC CE and may be received on different cells (e.g., PCells only, SCells only, PCells and SCells). In some cases, the control signaling associated with TA value validation, the downlink reference signals for measurements, the SCell de-activation message and the SCell activation message may be transmitted on the PCell 225, the SCell 230, or a combination thereof.

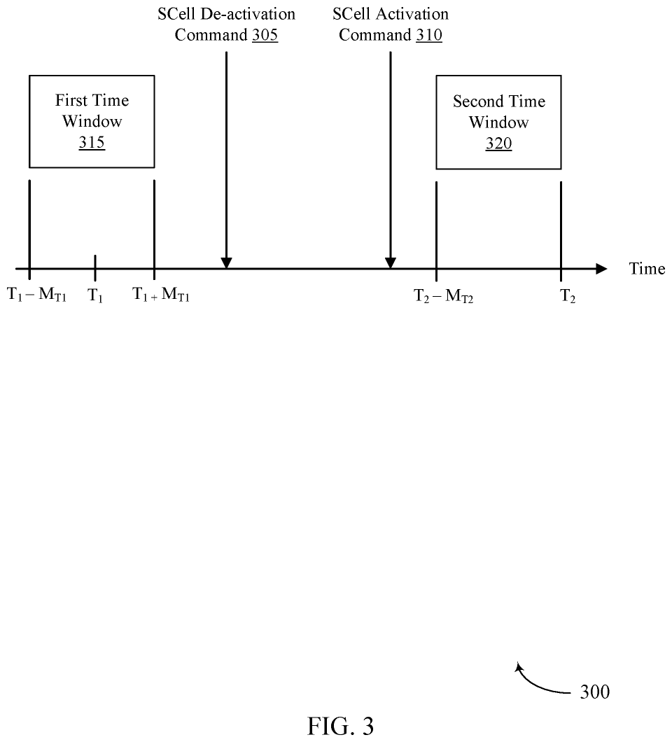

FIG. 3 shows an example of a timing diagram 300 that supports techniques for TA validation for SCell activation in accordance with one or more aspects of the present disclosure. The timing diagram 300 may implement or be implemented by aspects of the wireless communications systems 100 and 200 as described with reference to FIGS. 1 and 2, respectively. For example, the timing diagram 300 may be implemented by a UE, which may be an example of the UEs as described with reference to FIGS. 1 and 2.

The timing diagram 300 illustrates an example of the timing for measurements and signaling associated with the TA value validation procedure described herein. In some examples, the UE 115-a may receive the SCell de-activation command 305. Prior to receiving the SCell de-activation command 305, the UE 115-a may measure the first signal quality metric RSRP₁ within a first time window 315. The first time window 315 may be given by [T₁−M_{T1}, T₁+M_{T}], where T₁ is a time that the UE 115-a obtains the last TA value (N_{TA_last}) from the network entity 105-a (e.g., in a TA command MAC CE) and M_{T1} (first duration of time) is determined by a measurement cycle of the SCell 230, the frequency range, and a scaling factor configured by network entity 105-b. The network entity 105-a may transmit, to the UE 115-a, control signaling (e.g., control signaling 215) that indicates the M_{T1} (e.g., first duration of time). The control signaling may be RRC signaling, DCI or a MAC CE and may be received on different cells (e.g., PCells only, SCells only, PCells and SCells).

In some examples, the UE 115-a may receive the SCell activation command 310. After receiving the SCell activation command 310, the UE 115-a may measure the second signal quality metric RSRP₂ within a second time window 320. The second time window 320 may be given by [T₂−M_{T2}, T₂], where T₂ is the time that UE performs TA validation and M_{T2} (second duration of time) is determined by the measurement cycle of the SCell 230, the frequency range, and a scaling factor configured by network entity 105-a. The network entity 105-a may transmit, to the UE 115-a, control signaling (e.g., control signaling 215) that indicates the MTs (second duration of time). The control signaling may be RRC signaling, DCI or a MAC CE and may be received on different cells (e.g., PCells only, SCells only, PCells and SCells).

In some cases, the first signal quality metric (RSRP₁) and the second signal quality metric (RSRP₂) may be based on the downlink RS of a cell defining synchronization signal block (CD-SSB), a non-cell defining synchronization signal block (NCD-SSB), a tracking reference signal (TRS) or a channel state information reference signal (CSI-RS). In some cases, the first signal quality metric (RSRP₁) and the second signal quality metric (RSRP₂) may be based on the same type of downlink RS or different types of downlink RS. For example, the first second signal quality metric (RSRP₁) may be based on the CD-SSB and the second signal quality metric (RSRP₂) may be based on the CD-SSB, the first second signal quality metric (RSRP₁) may be based on the CD-SSB and the second signal quality metric (RSRP₂) may be based on the NCD-SSB, the first second signal quality metric (RSRP₁) may be based on the CD-SSB and the second signal quality metric (RSRP₂) may be based on the TRS/CSI-RS, the first second signal quality metric (RSRP₁) may be based on the NCD-SSB and the second signal quality metric (RSRP₂) may be based on the NCD-SSB, the first second signal quality metric (RSRP₁) may be based on the NCD-SSB and the second signal quality metric (RSRP₂) may be based on the TRS/CSI-RS, the first second signal quality metric (RSRP₁) may be based on the TRS/CSI-RS and the second signal quality metric (RSRP₂) may be based on the TRS/CSI-RS. In some examples, the first signal quality metric (RSRP₁) and the second signal quality metric (RSRP₂) may be made on different cells that share the same TAG with the PUCCH SCell 230. In some cases, the downlink reference signals may be received on different cells (e.g., PCells 225 only, SCells 230 only, PCells 225 and SCells 230).

In some examples, the UE 115-a may determine that the last TA value (N_{TA_last}) is valid based on determining that the difference between the first signal quality metric (RSRP₁) and the second signal quality metric (RSRP₂) is less than or equal to a threshold (SCell-RSRP-ChangeThreshold). If the last TA value (N_{TA_last}) is determined valid, the UE 115-a may reuse the TA value (N_{TA_last}) for uplink transmissions. In some examples, the UE 115-a may determine the last TA value (N_{TA_last}) to be invalid based on determining that the difference between the first signal quality metric (RSRP₁) and the second signal quality metric (RSRP₂) is greater than the threshold (SCell-RSRP-ChangeThreshold). If the last TA value (N_{TA_last}) is determined invalid, the UE 115-a may suspend uplink transmissions (e.g., PUCCH transmissions, sounding reference signal transmissions and physical uplink shared channel transmissions) on the first TAG associated with the SCell 230. If the last TA value (N_{TA_last}) is determined invalid, the UE 115-a may discard the TA value associated with the first TAG and may transmit control signaling (e.g., control signaling 205) that requests the network entity 105-a to issue a physical downlink control channel (PDCCH) order for a RA procedure to re-acquire the uplink timing associated with the first TAG. In some examples, the control signaling that requests the PDCCH ordered RA may be transmitted on an activated PCell 225 or a second SCell associated with a second TAG and having a valid TA. The RA ordered by the PDCCH may be initiated by UE 115-a on a PCell or the SCell with the first TAG.

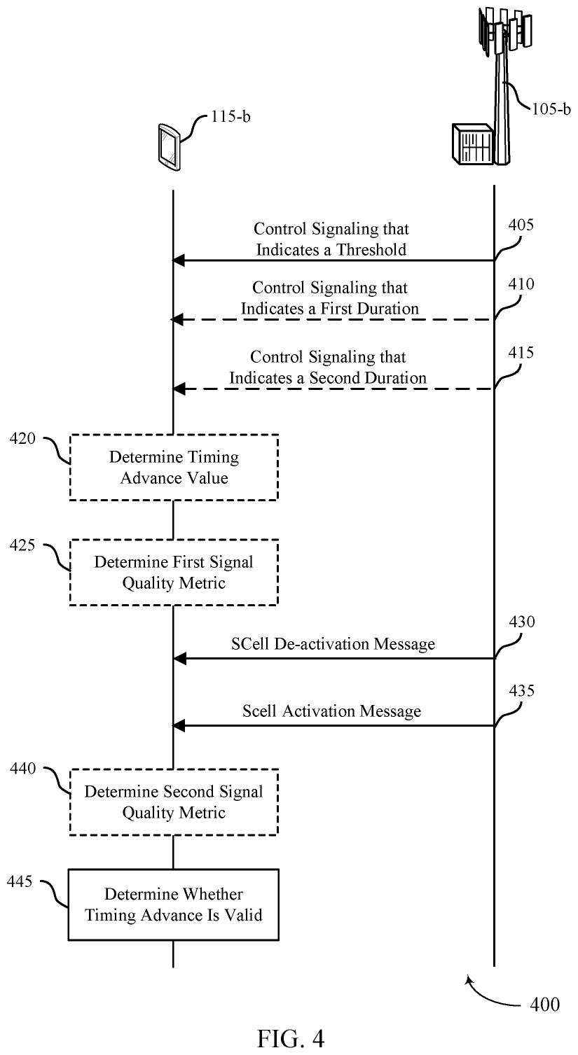

FIG. 4 shows an example of a process flow 400 that supports techniques for TA validation for SCell activation in accordance with one or more aspects of the present disclosure. In some examples, the process flow 400 may implement or be implemented by aspects of the wireless communications systems 100 and 200 as described with reference to FIGS. 1 and 2, respectively. For example, the process flow 400 may be implemented by a network entity 105-b, which may be an example of the network entities 105 as described with reference to FIGS. 1 and 2. The process flow 400 may be implemented by a UE 115-b, which may be an example of the UEs as described with reference to FIGS. 1 and 2.

In some examples, the operations illustrated in process flow 400 may be performed by hardware (e.g., including circuitry, processing blocks, logic components, and other components), code (e.g., software executed by a processor), or any combination thereof. Alternative examples of the following may be implemented, where some steps are performed in a different order than described or are not performed at all. In some cases, steps may include additional features not mentioned below, or further steps may be added.

At 405, the network entity 105-b may transmit, to the UE 115-b, a threshold (e.g., SCell-RSRP-ChangeThreshold) associated with a difference between a first signal quality metric and a second signal quality metric.

At 410, the network entity 105-b may transmit, to the UE 115-b, control signaling that indicates a first duration of time (e.g., M_{T1}) associated with a determination of a first signal quality metric (RSRP₁). In some examples, the first duration may be based on a measurement cycle of a SCell, a frequency range, a scaling factor or a combination thereof.

At 415, the network entity 105-b may transmit, to the UE 115-b, control signaling that indicates a second duration of time (e.g., M_{T2}) associated with a determination of a second signal quality metric (e.g., RSRP₂). In some examples, the second duration may be based on a measurement cycle of the SCell, a frequency range, a scaling factor or a combination thereof.

At 420, the UE 115-b may determine a TA value for an uplink transmission to a SCell. In some cases, the UE 115-b may determine the TA value at a first time. In some cases, the UE 115-b may determine the TA value prior to receiving a SCell de-activation message. In some examples, the UE 115-b may be in a RRC connected mode during the determination of the TA value.

At 425, the UE 115-b may determine the first signal quality metric (e.g., RSRP₁) associated with wireless communications between the UE 115-b and the SCell. In some examples, the UE 115-b may determine the first signal quality metric within a first time window based at least in part on the first duration and the first time. In some examples, the first signal quality metric may be determined based at least in part on a CD-SSB, a NCD-SSB, a TRS or a CSI-RS. In some examples, the UE 115-b may be in a RRC connected mode during the determination of the first signal quality metric. In some examples, the first signal quality metric is a RSRP determination.

At 430, the UE 115-b may receive a SCell de-activation message associated with the SCell. In some examples, the SCell is configured with PUCCH resources. In some examples, the UE 115-b may receive the SCell de-activation message after determination by the UE 115-b of the TA value for the uplink transmission to the SCell and after determination of the first signal quality metric associated with wireless communications between the UE 115-b and the SCell.

At 435, the UE 115-b may receive a SCell activation message associated with the SCell.

At 440, the UE 115-b may determine the second signal quality metric (RSRP₂). In some examples, the UE 115-b may determine the second signal quality metric within a second first time window based at least in part on the second duration and a time for which validity of the TA value is evaluated. In some examples, the second signal quality metric may be determined based at least in part on a CD-SSB, a NCD-SSB, a positioning reference signal, an integrated signal for communication and sensing, a TRS or a CSI-RS, or a combination thereof. In some examples, the second signal quality metric is a RSRP determination. In some examples, the first signal quality metric and the second signal quality metric may be determined based at least in part on a same type of downlink reference signal or a different type of downlink reference signal. In some examples, the first signal quality metric and the second signal quality metric may be determined on different cells having a same TAG as the SCell.

At 445, the UE 115-b may determine, in response to receiving the SCell activation message, whether the TA value determined prior to receipt of the SCell de-activation message is valid for the wireless communications between the UE and the SCell after receipt of the SCell activation message based at least in part on a difference between the first signal quality metric and a second signal quality metric, where the second signal quality metric is determined after receipt of the SCell activation message. In some examples, the UE 115-b may determine the difference between the first signal quality metric and the second signal quality metric is less than or equal to the threshold to determine that the TA value is valid. In some examples, the UE 115-b may reuse the TA value based on the difference between the first signal quality metric and the second signal quality metric satisfying the threshold.

In some examples, the UE 115-b may determine that the difference between the first signal quality metric and the second signal quality metric is greater than the threshold to determine that the TA value is invalid. In some examples, if the difference between the first signal quality metric and the second signal quality metric is greater than the threshold, the UE 115-b may suspend an uplink transmission on a first TAG associated with the SCell, may discard the TA value associated with the first TAG, and may transmit, to the network entity 105-b, first control signaling that requests the network entity 105-b to issue an order for a RA procedure to acquire a second TA value associated with the first TAG. In some examples, the control signaling that requests the network entity to issue the order for the random access procedure may be transmitted on an activated PCell or a second SCell associated with a second TAG and the second SCell has a valid TA value

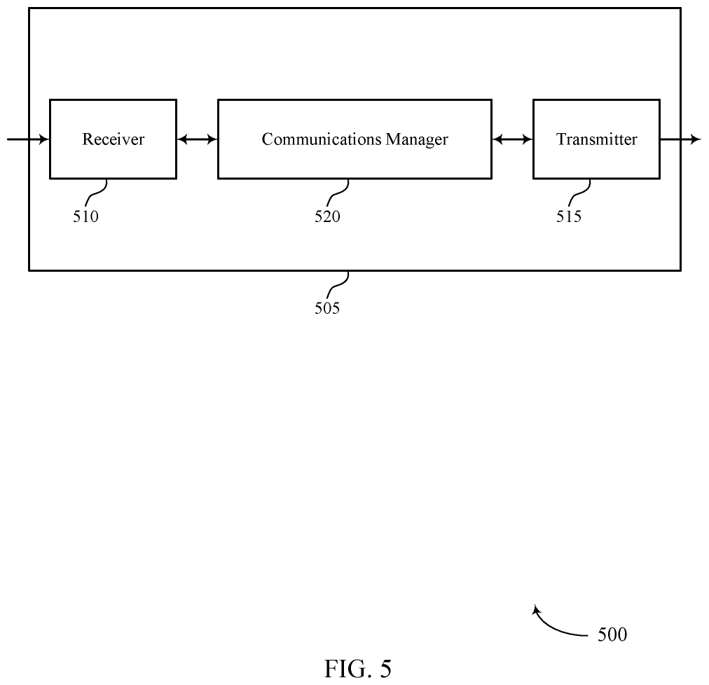

FIG. 5 shows a block diagram 500 of a device 505 that supports techniques for TA validation for SCell activation in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for TA validation for SCell activation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for TA validation for SCell activation). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for TA validation for SCell activation as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. For example, the communications manager 520 is capable of, configured to, or operable to support a means for receiving a SCell de-activation message associated with a SCell, the SCell de-activation message received after determination by the UE of a TA value for an uplink transmission to the SCell and after determination of a first signal quality metric associated with wireless communications between the UE and the SCell. The communications manager 520 is capable of, configured to, or operable to support a means for receiving a SCell activation message associated with the SCell. The communications manager 520 is capable of, configured to, or operable to support a means for determining, in response to receiving the SCell activation message, whether the TA value determined prior to receipt of the SCell de-activation message is valid for the wireless communications between the UE and the SCell after receipt of the SCell activation message based on a difference between the first signal quality metric and a second signal quality metric, where the second signal quality metric is determined after receipt of the SCell activation message.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources.

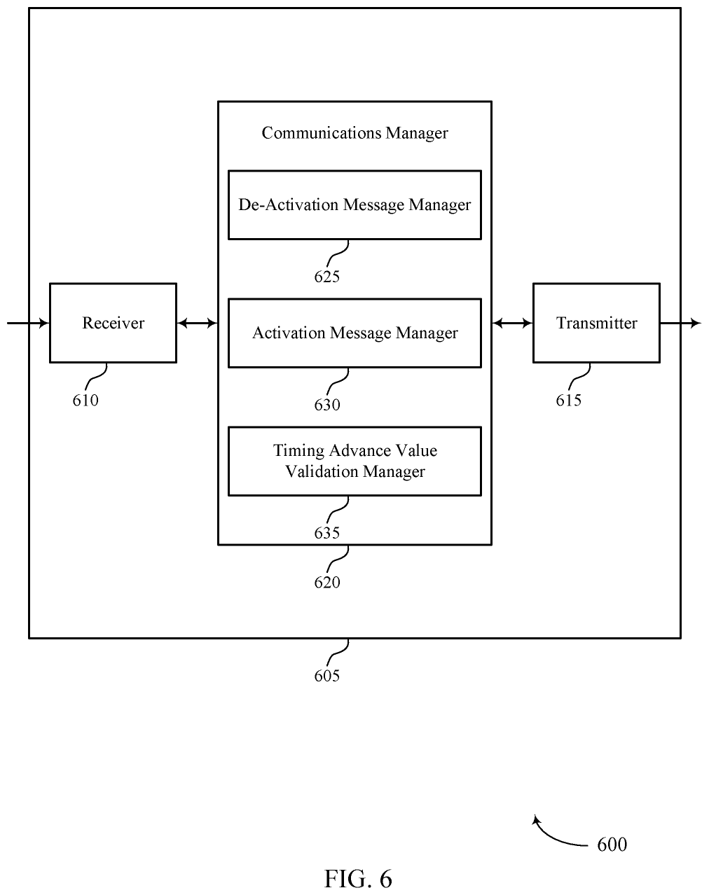

FIG. 6 shows a block diagram 600 of a device 605 that supports techniques for TA validation for SCell activation in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for TA validation for SCell activation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for TA validation for SCell activation). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for TA validation for SCell activation as described herein. For example, the communications manager 620 may include a de-activation message manager 625, an activation message manager 630, a TA value validation manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. The de-activation message manager 625 is capable of, configured to, or operable to support a means for receiving a SCell de-activation message associated with a SCell, the SCell de-activation message received after determination by the UE of a TA value for an uplink transmission to the SCell and after determination of a first signal quality metric associated with wireless communications between the UE and the SCell. The activation message manager 630 is capable of, configured to, or operable to support a means for receiving a SCell activation message associated with the SCell. The TA value validation manager 635 is capable of, configured to, or operable to support a means for determining, in response to receiving the SCell activation message, whether the TA value determined prior to receipt of the SCell de-activation message is valid for the wireless communications between the UE and the SCell after receipt of the SCell activation message based on a difference between the first signal quality metric and a second signal quality metric, where the second signal quality metric is determined after receipt of the SCell activation message.

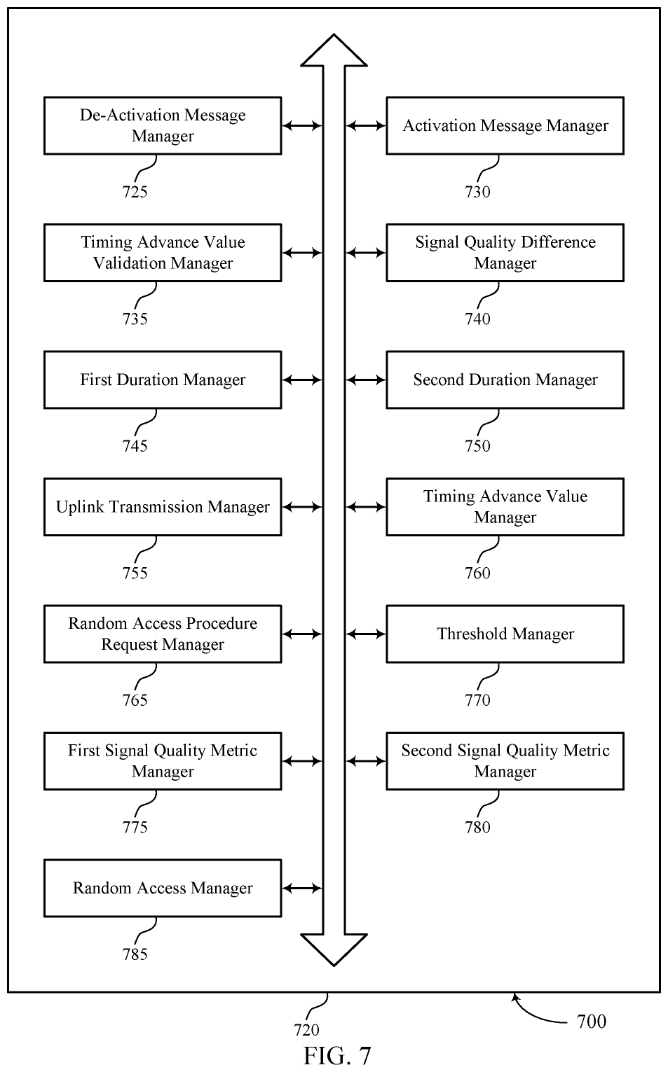

FIG. 7 shows a block diagram 700 of a communications manager 720 that supports techniques for TA validation for SCell activation in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for TA validation for SCell activation as described herein. For example, the communications manager 720 may include a de-activation message manager 725, an activation message manager 730, a TA value validation manager 735, a signal quality difference manager 740, a first duration manager 745, a second duration manager 750, an uplink transmission manager 755, a TA value manager 760, a random access procedure request manager 765, a threshold manager 770, a first signal quality metric manager 775, a second signal quality metric manager 780, a random access manager 785, or any combination thereof. Each of these components, or components or subcomponents thereof (e.g., one or more processors, one or more memories), may communicate, directly or indirectly, with one another (e.g., via one or more buses).

The communications manager 720 may support wireless communication in accordance with examples as disclosed herein. The de-activation message manager 725 is capable of, configured to, or operable to support a means for receiving a SCell de-activation message associated with a SCell, the SCell de-activation message received after determination by the UE of a TA value for an uplink transmission to the SCell and after determination of a first signal quality metric associated with wireless communications between the UE and the SCell. The activation message manager 730 is capable of, configured to, or operable to support a means for receiving a SCell activation message associated with the SCell. The TA value validation manager 735 is capable of, configured to, or operable to support a means for determining, in response to receiving the SCell activation message, whether the TA value determined prior to receipt of the SCell de-activation message is valid for the wireless communications between the UE and the SCell after receipt of the SCell activation message based on a difference between the first signal quality metric and a second signal quality metric, where the second signal quality metric is determined after receipt of the SCell activation message.

In some examples, to support determining whether the TA value is valid for the wireless communications between the UE and the SCell after receipt of the SCell activation message, the signal quality difference manager 740 is capable of, configured to, or operable to support a means for determining that the difference between the first signal quality metric and the second signal quality metric is less than or equal to a threshold. In some examples, to support determining whether the TA value is valid for the wireless communications between the UE and the SCell after receipt of the SCell activation message, the TA value validation manager 735 is capable of, configured to, or operable to support a means for reusing the TA value based on the difference satisfying the threshold.

In some examples, the threshold manager 770 is capable of, configured to, or operable to support a means for receiving control signaling that indicates the threshold.

In some examples, the first duration manager 745 is capable of, configured to, or operable to support a means for receiving control signaling that indicates a first duration of time associated with a determination of the first signal quality metric.

In some examples, the TA value manager 760 is capable of, configured to, or operable to support a means for determining the TA value at a first time. In some examples, the first signal quality metric manager 775 is capable of, configured to, or operable to support a means for determining the first signal quality metric within a first time window based on the first duration and the first time.

In some examples, the first duration is based in part on a measurement cycle of the SCell, a frequency range, a scaling factor or a combination thereof.

In some examples, the second duration manager 750 is capable of, configured to, or operable to support a means for receiving control signaling that indicates a second duration associated with a determination of the second signal quality metric.

In some examples, the second signal quality metric manager 780 is capable of, configured to, or operable to support a means for determining the second signal quality metric within a second time window based on the second duration and a time for which validity of the TA value is evaluated.

In some examples, the second duration is based in part on a measurement cycle of the SCell, a frequency range, a scaling factor or a combination thereof.

In some examples, the first signal quality metric is determined based on a cell defining synchronization signal block, a non-cell defining synchronization signal block, a tracking reference signal or a channel state information reference signal.

In some examples, to support determining whether the TA value is valid for the wireless communications between the UE and the SCell after receipt of the SCell activation message, the TA value validation manager 735 is capable of, configured to, or operable to support a means for determining that the difference between the first signal quality metric and the second signal quality metric is greater than a threshold. In some examples, the uplink transmission manager 755 is capable of, configured to, or operable to support a means for suspending an uplink transmission on a first TAG associated with the SCell. In some examples, the TA value manager 760 is capable of, configured to, or operable to support a means for discarding the TA value associated with the first TAG. In some examples, the random access procedure request manager 765 is capable of, configured to, or operable to support a means for transmitting, to the network entity, first control signaling that requests the network entity to issue an order for a random access procedure to acquire a second TA value associated with the first TAG.

In some examples, the control signaling that requests the network entity to issue the order for the random access procedure is transmitted on an activated PCell or a second SCell associated with a second TAG and the second SCell has a valid TA value, and the random access procedure request manager 765 is capable of, configured to, or operable to support a means for receiving second control signaling that indicates the order for the random access procedure. In some examples, the control signaling that requests the network entity to issue the order for the random access procedure is transmitted on an activated PCell or a second SCell associated with a second TAG and the second SCell has a valid TA value, and the random access manager 785 is capable of, configured to, or operable to support a means for initiating the random access procedure on the activated PCell or the SCell associated with the first TAG.

In some examples, the first signal quality metric and the second signal quality metric are determined based on a same type of downlink reference signal or a different type of downlink reference signal.

In some examples, the first signal quality metric and the second signal quality metric are determined on different cells having a same TAG as the SCell.

In some examples, the SCell is configured with PUCCH resources.

In some examples, the first signal quality metric and the second signal quality metric are both RSRP determinations.

In some examples, the UE is in an RRC connected mode during the determination the TA value and during the determination of the first signal quality metric.

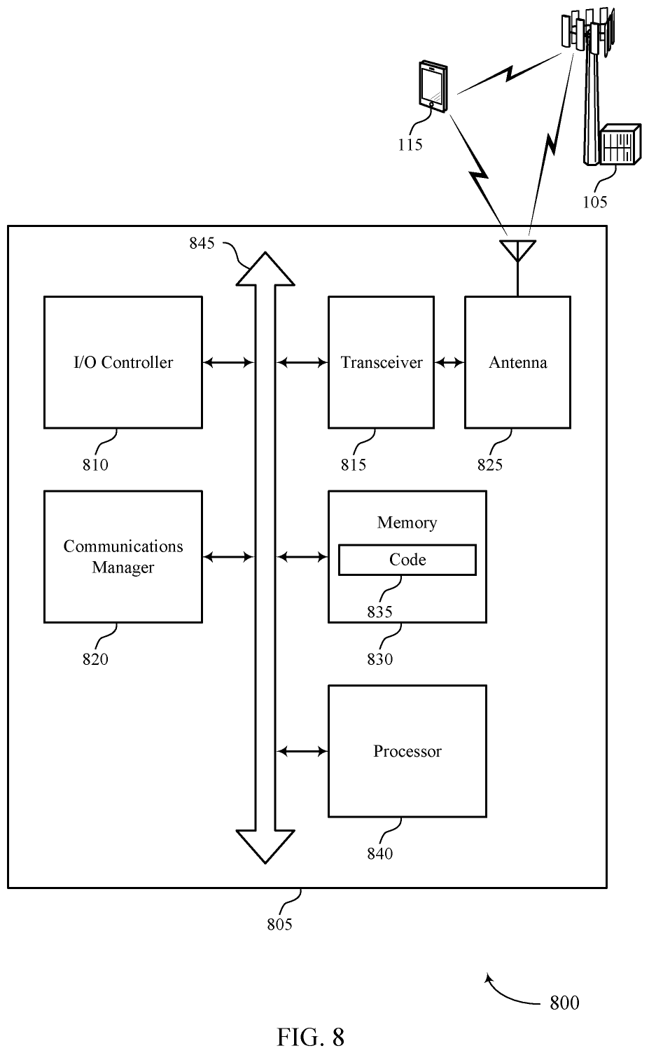

FIG. 8 shows a diagram of a system 800 including a device 805 that supports techniques for TA validation for SCell activation in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOSR, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for TA validation for SCell activation). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. As such, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

The communications manager 820 may support wireless communication in accordance with examples as disclosed herein. For example, the communications manager 820 is capable of, configured to, or operable to support a means for receiving a SCell de-activation message associated with a SCell, the SCell de-activation message received after determination by the UE of a TA value for an uplink transmission to the SCell and after determination of a first signal quality metric associated with wireless communications between the UE and the SCell. The communications manager 820 is capable of, configured to, or operable to support a means for receiving a SCell activation message associated with the SCell. The communications manager 820 is capable of, configured to, or operable to support a means for determining, in response to receiving the SCell activation message, whether the TA value determined prior to receipt of the SCell de-activation message is valid for the wireless communications between the UE and the SCell after receipt of the SCell activation message based on a difference between the first signal quality metric and a second signal quality metric, where the second signal quality metric is determined after receipt of the SCell activation message.

By including or configuring the communications manager 820 in accordance with examples as described herein, the device 805 may support techniques for reduced latency, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for TA validation for SCell activation as described herein, or the at least one processor 840 and the at least one memory 830 may be otherwise configured to, individually or collectively, perform or support such operations.

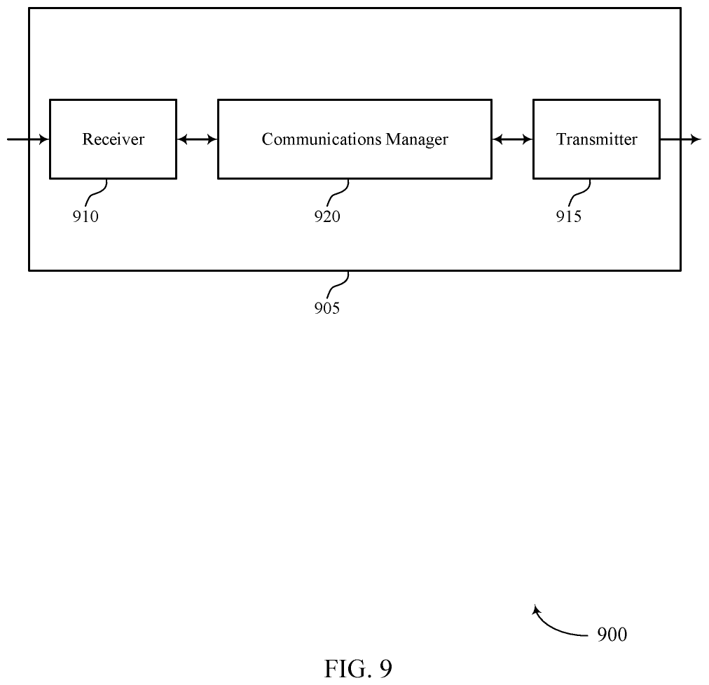

FIG. 9 shows a block diagram 900 of a device 905 that supports techniques for TA validation for SCell activation in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of techniques for TA validation for SCell activation as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. For example, the communications manager 920 is capable of, configured to, or operable to support a means for transmitting, to a UE, a first control signaling that indicates a threshold associated with determining that a TA value is valid. The communications manager 920 is capable of, configured to, or operable to support a means for transmitting, to the UE and after transmission of the first control signaling, a SCell de-activation message associated with a SCell. The communications manager 920 is capable of, configured to, or operable to support a means for transmitting, to the UE, a SCell activation message associated with the SCell, where the SCell activation message is transmitted prior to a determination that the TA value is valid.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources.

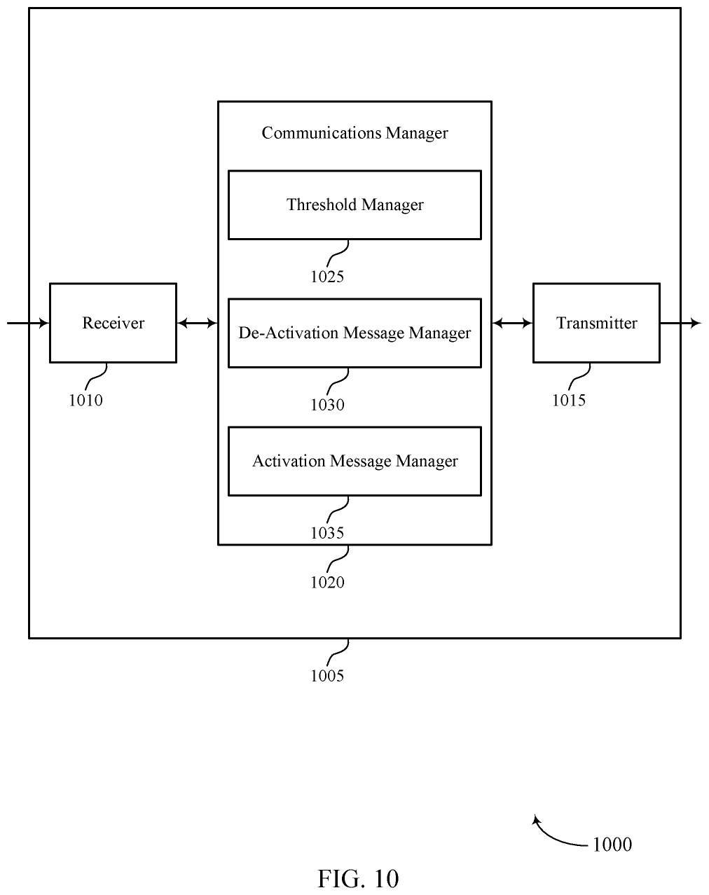

FIG. 10 shows a block diagram 1000 of a device 1005 that supports techniques for TA validation for SCell activation in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for TA validation for SCell activation as described herein. For example, the communications manager 1020 may include a threshold manager 1025, a de-activation message manager 1030, an activation message manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. The threshold manager 1025 is capable of, configured to, or operable to support a means for transmitting, to a UE, a first control signaling that indicates a threshold associated with determining that a TA value is valid. The de-activation message manager 1030 is capable of, configured to, or operable to support a means for transmitting, to the UE and after transmission of the first control signaling, a SCell de-activation message associated with a SCell. The activation message manager 1035 is capable of, configured to, or operable to support a means for transmitting, to the UE, a SCell activation message associated with the SCell, where the SCell activation message is transmitted prior to a determination that the TA value is valid.

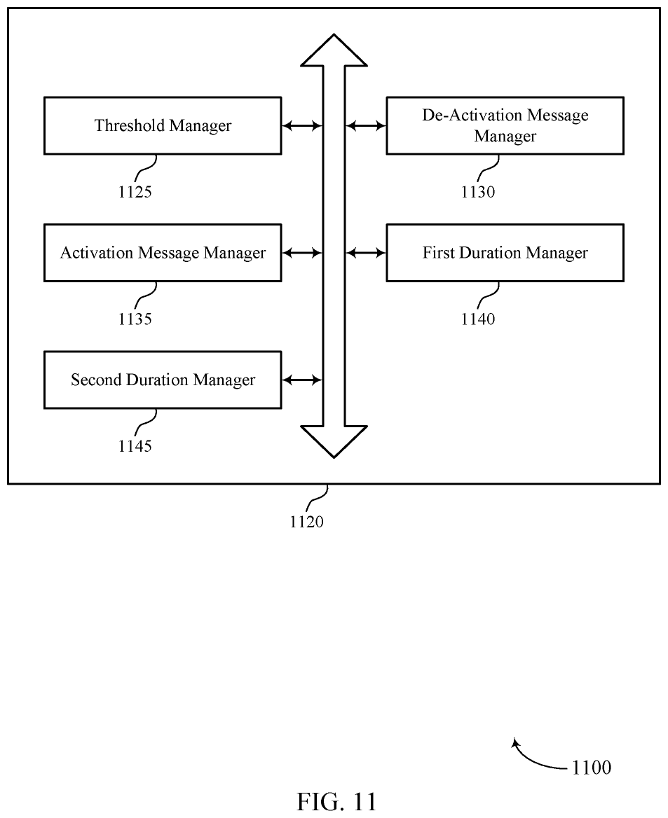

FIG. 11 shows a block diagram 1100 of a communications manager 1120 that supports techniques for TA validation for SCell activation in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for TA validation for SCell activation as described herein. For example, the communications manager 1120 may include a threshold manager 1125, a de-activation message manager 1130, an activation message manager 1135, a first duration manager 1140, a second duration manager 1145, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication in accordance with examples as disclosed herein. The threshold manager 1125 is capable of, configured to, or operable to support a means for transmitting, to a UE, a first control signaling that indicates a threshold associated with determining that a TA value is valid. The de-activation message manager 1130 is capable of, configured to, or operable to support a means for transmitting, to the UE and after transmission of the first control signaling, a SCell de-activation message associated with a SCell. The activation message manager 1135 is capable of, configured to, or operable to support a means for transmitting, to the UE, a SCell activation message associated with the SCell, where the SCell activation message is transmitted prior to a determination that the TA value is valid.

In some examples, the first duration manager 1140 is capable of, configured to, or operable to support a means for transmitting, to the UE, control signaling that indicates a first duration of time associated with a determination of a first signal quality metric at the UE, where the determination of the first signal quality metric is prior to transmission of the SCell de-activation message.

In some examples, the first duration is based in part on a measurement cycle of the SCell, a frequency range, a scaling factor or a combination thereof.

In some examples, the second duration manager 1145 is capable of, configured to, or operable to support a means for transmitting, to the UE, control signaling that indicates a second duration of time associated with a determination of a second signal quality metric at the UE, where the SCell activation message is transmitted prior to the determination of the second signal quality metric.

In some examples, the second duration is based in part on a measurement cycle of the SCell, a frequency range, a scaling factor or a combination thereof. In some examples, the SCell is configured with PUCCH resources.

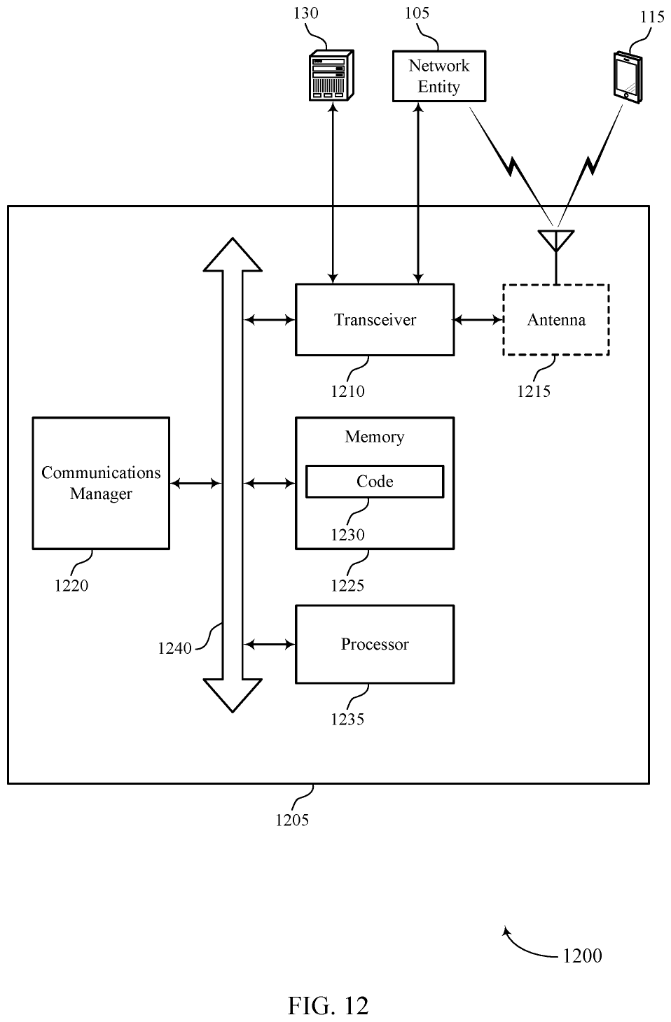

FIG. 12 shows a diagram of a system 1200 including a device 1205 that supports techniques for TA validation for SCell activation in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for TA validation for SCell activation). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. As such, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication in accordance with examples as disclosed herein. For example, the communications manager 1220 is capable of, configured to, or operable to support a means for transmitting, to a UE, a first control signaling that indicates a threshold associated with determining that a TA value is valid. The communications manager 1220 is capable of, configured to, or operable to support a means for transmitting, to the UE and after transmission of the first control signaling, a SCell de-activation message associated with a SCell. The communications manager 1220 is capable of, configured to, or operable to support a means for transmitting, to the UE, a SCell activation message associated with the SCell, where the SCell activation message is transmitted prior to a determination that the TA value is valid.

By including or configuring the communications manager 1220 in accordance with examples as described herein, the device 1205 may support techniques for reduced latency, more efficient utilization of communication resources, and improved coordination between devices.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for TA validation for SCell activation as described herein, or the at least one processor 1235 and the at least one memory 1225 may be otherwise configured to, individually or collectively, perform or support such operations.

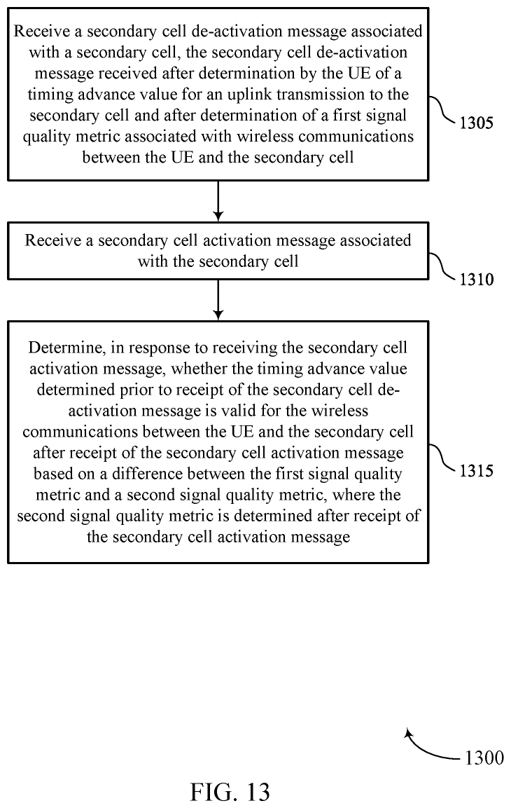

FIG. 13 shows a flowchart illustrating a method 1300 that supports techniques for TA validation for SCell activation in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a SCell de-activation message associated with a SCell, the SCell de-activation message received after determination by the UE of a TA value for an uplink transmission to the SCell and after determination of a first signal quality metric associated with wireless communications between the UE and the SCell. The operations of block 1305 may be performed in accordance with examples as disclosed herein. In some examples, aspects of the operations of 1305 may be performed by a de-activation message manager 725 as described with reference to FIG. 7.

At 1310, the method may include receiving a SCell activation message associated with the SCell. The operations of block 1310 may be performed in accordance with examples as disclosed herein. In some examples, aspects of the operations of 1310 may be performed by an activation message manager 730 as described with reference to FIG. 7.

At 1315, the method may include determining, in response to receiving the SCell activation message, whether the TA value determined prior to receipt of the SCell de-activation message is valid for the wireless communications between the UE and the SCell after receipt of the SCell activation message based on a difference between the first signal quality metric and a second signal quality metric, where the second signal quality metric is determined after receipt of the SCell activation message. The operations of block 1315 may be performed in accordance with examples as disclosed herein. In some examples, aspects of the operations of 1315 may be performed by a TA value validation manager 735 as described with reference to FIG. 7.

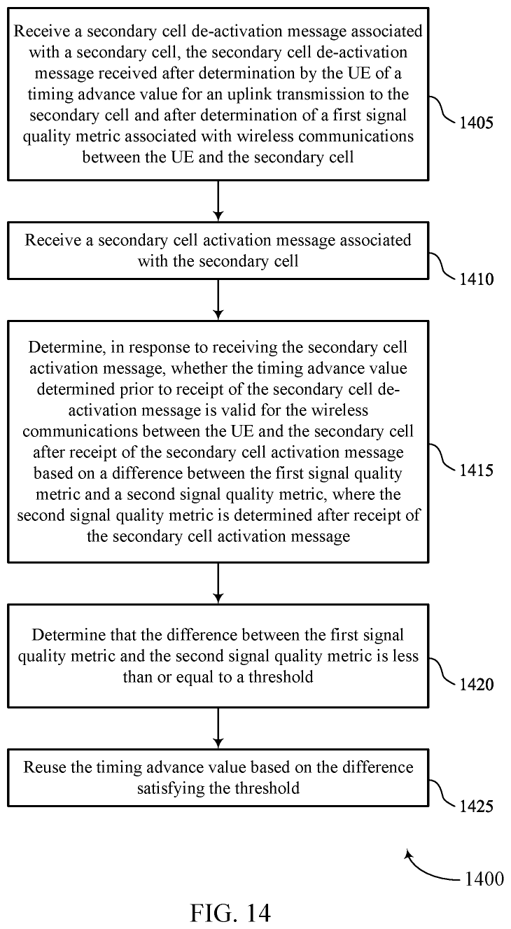

FIG. 14 shows a flowchart illustrating a method 1400 that supports techniques for TA validation for SCell activation in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a SCell de-activation message associated with a SCell, the SCell de-activation message received after determination by the UE of a TA value for an uplink transmission to the SCell and after determination of a first signal quality metric associated with wireless communications between the UE and the SCell. The operations of block 1405 may be performed in accordance with examples as disclosed herein. In some examples, aspects of the operations of 1405 may be performed by a de-activation message manager 725 as described with reference to FIG. 7.

At 1410, the method may include receiving a SCell activation message associated with the SCell. The operations of block 1410 may be performed in accordance with examples as disclosed herein. In some examples, aspects of the operations of 1410 may be performed by an activation message manager 730 as described with reference to FIG. 7.

At 1415, the method may include determining, in response to receiving the SCell activation message, whether the TA value determined prior to receipt of the SCell de-activation message is valid for the wireless communications between the UE and the SCell after receipt of the SCell activation message based on a difference between the first signal quality metric and a second signal quality metric, where the second signal quality metric is determined after receipt of the SCell activation message. The operations of block 1415 may be performed in accordance with examples as disclosed herein. In some examples, aspects of the operations of 1415 may be performed by a TA value validation manager 735 as described with reference to FIG. 7.

At 1420, the method may include determining that the difference between the first signal quality metric and the second signal quality metric is less than or equal to a threshold. The operations of block 1420 may be performed in accordance with examples as disclosed herein. In some examples, aspects of the operations of 1420 may be performed by a signal quality difference manager 740 as described with reference to FIG. 7.

At 1425, the method may include reusing the TA value based on the difference satisfying the threshold. The operations of block 1425 may be performed in accordance with examples as disclosed herein. In some examples, aspects of the operations of 1425 may be performed by a TA value validation manager 735 as described with reference to FIG. 7.

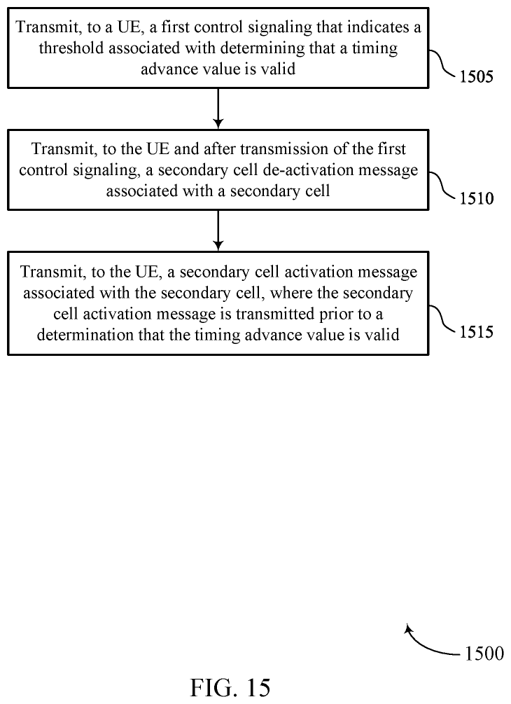

FIG. 15 shows a flowchart illustrating a method 1500 that supports techniques for TA validation for SCell activation in accordance with aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include transmitting, to a UE, a first control signaling that indicates a threshold associated with determining that a TA value is valid. The operations of block 1505 may be performed in accordance with examples as disclosed herein. In some examples, aspects of the operations of 1505 may be performed by a threshold manager 1125 as described with reference to FIG. 11.

At 1510, the method may include transmitting, to the UE and after transmission of the first control signaling, a SCell de-activation message associated with a SCell. The operations of block 1510 may be performed in accordance with examples as disclosed herein. In some examples, aspects of the operations of 1510 may be performed by a de-activation message manager 1130 as described with reference to FIG. 11.

At 1515, the method may include transmitting, to the UE, a SCell activation message associated with the SCell, where the SCell activation message is transmitted prior to a determination that the TA value is valid. The operations of block 1515 may be performed in accordance with examples as disclosed herein. In some examples, aspects of the operations of 1515 may be performed by an activation message manager 1135 as described with reference to FIG. 11.

The following provides an overview of aspects of the present disclosure:

Aspect 1: A method for wireless communication by UE, comprising: receiving a secondary cell de-activation message associated with a secondary cell, the secondary cell de-activation message received after determination by the UE of a timing advance value for an uplink transmission to the secondary cell and after determination of a first signal quality metric associated with wireless communications between the UE and the secondary cell; receiving a secondary cell activation message associated with the secondary cell; and determining, in response to receiving the secondary cell activation message, whether the timing advance value determined prior to receipt of the secondary cell de-activation message is valid for the wireless communications between the UE and the secondary cell after receipt of the secondary cell activation message based at least in part on a difference between the first signal quality metric and a second signal quality metric, wherein the second signal quality metric is determined after receipt of the secondary cell activation message.

Aspect 2: The method of aspect 1, wherein determining whether the timing advance value is valid for the wireless communications between the UE and the secondary cell after receipt of the secondary cell activation message further comprises: determining that the difference between the first signal quality metric and the second signal quality metric is less than or equal to a threshold, the method further comprising: reusing the timing advance value based at least in part on the difference satisfying the threshold.

Aspect 3: The method of aspect 2, further comprising: receiving control signaling that indicates the threshold.

Aspect 4: The method of any of aspects 1 through 3, further comprising:

receiving control signaling a first duration of time associated with a determination of the first signal quality metric.

Aspect 5: The method of aspect 4, further comprising: determining the timing advance value at a first time; and determining the first signal quality metric within a first time window based at least in part on the first duration and the first time.

Aspect 6: The method of any of aspects 4 through 5, wherein the first duration is based in part on a measurement cycle of the secondary cell, a frequency range, a scaling factor or a combination thereof.

Aspect 7: The method of any of aspects 1 through 6, further comprising: receiving control signaling that indicates a second duration associated with a determination of the second signal quality metric.

Aspect 8: The method of aspect 7, further comprising: determining the second signal quality metric within a second time window based at least in part on the second duration and a time for which validity of the timing advance value is evaluated.

Aspect 9: The method of any of aspects 7 through 8, wherein the second duration is based in part on a measurement cycle of the secondary cell, a frequency range, a scaling factor or a combination thereof.

Aspect 10: The method of any of aspects 1 through 9, wherein the first signal quality metric is determined based at least in part on a cell defining synchronization signal block, a non-cell defining synchronization signal block, a tracking reference signal or a channel state information reference signal.

Aspect 11: The method of any of aspects 1 through 10, wherein determining whether the timing advance value is valid for the wireless communications between the UE and the secondary cell after receipt of the secondary cell activation message further comprises: determining that the difference between the first signal quality metric and the second signal quality metric is greater than a threshold, the method further comprising: suspending an uplink transmission on a first timing advance group (TAG) associated with the secondary cell, discarding the timing advance value associated with the first TAG; and transmitting, to the network entity, first control signaling that requests the network entity to issue an order for a random access procedure to acquire a second timing advance value associated with the first TAG.

Aspect 12: The method of aspect 11, wherein the control signaling that requests the network entity to issue the order for the random access procedure is transmitted on an activated primary cell or a second secondary cell associated with a secondary TAG and the second secondary cell has a valid timing advance value, the method further comprising: receiving second control signaling that indicates the order for the random access procedure; and initiating the random access procedure on the activated primary cell or the secondary cell associated with the first TAG.

Aspect 13: The method of any of aspects 1 through 12, wherein the first signal quality metric and the second signal quality metric are determined based at least in part on a same type of downlink reference signal or a different type of downlink reference signal.

Aspect 14: The method of any of aspects 1 through 13, wherein the first signal quality metric and the second signal quality metric are determined on different cells having a same timing advance group as the secondary cell.

Aspect 15: The method of any of aspects 1 through 14, wherein the secondary cell is configured with physical uplink control channel resources.

Aspect 16: The method of any of aspects 1 through 15, wherein the first signal quality metric and the second signal quality metric are both reference signal received power (RSRP) determinations.

Aspect 17: The method of any of aspects 1 through 16, wherein the UE is in an RRC connected mode during the determination the timing advance value and during the determination of the first signal quality metric.

Aspect 18: A method for wireless communication by network entity, comprising: transmitting, to a UE, a first control signaling that indicates a threshold associated with determining that a timing advance value is valid; transmitting, to the UE and after transmission of the first control signaling, a secondary cell de-activation message associated with a secondary cell; and transmitting, to the UE, a secondary cell activation message associated with the secondary cell, wherein the secondary cell activation message is transmitted prior to a determination that the timing advance value is valid.

Aspect 19: The method of aspect 18, further comprising: transmitting, to the UE, control signaling that indicates a first duration of time associated with a determination of a first signal quality metric at the UE, wherein the determination of the first signal quality metric is prior to transmission of the secondary cell de-activation message.

Aspect 20: The method of aspect 19, wherein the first duration is based in part on a measurement cycle of the secondary cell, a frequency range, a scaling factor or a combination thereof.

Aspect 21: The method of any of aspects 18 through 20, further comprising: transmitting, to the UE, control signaling that indicates a second duration of time associated with a determination of a second signal quality metric at the UE, wherein the secondary cell activation message is transmitted prior to the determination of the second signal quality metric.

Aspect 22: The method of aspect 21, wherein the second duration is based in part on a measurement cycle of the secondary cell, a frequency range, a scaling factor or a combination thereof.

Aspect 23: The method of any of aspects 18 through 22, wherein the secondary cell is configured with physical uplink control channel resources.

Aspect 24: A UE for wireless communication, comprising one or more memories storing processor-executable code, and one or more processors coupled with the one or more memories and individually or collectively operable to execute the code to cause the UE to perform a method of any of aspects 1 through 17.

Aspect 25: A UE for wireless communication, comprising at least one means for performing a method of any of aspects 1 through 17.

Aspect 26: A non-transitory computer-readable medium storing code for wireless communication, the code comprising instructions executable by a processor to perform a method of any of aspects 1 through 17.

Aspect 27: A network entity for wireless communication, comprising one or more memories storing processor-executable code, and one or more processors coupled with the one or more memories and individually or collectively operable to execute the code to cause the network entity to perform a method of any of aspects 18 through 23.

Aspect 28: A network entity for wireless communication, comprising at least one means for performing a method of any of aspects 18 through 23.

Aspect 29: A non-transitory computer-readable medium storing code for wireless communication, the code comprising instructions executable by a processor to perform a method of any of aspects 18 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a secondary cell de-activation message associated with a secondary cell, the secondary cell de-activation message received after determination by the UE of a timing advance value for an uplink transmission to the secondary cell and after determination of a first signal quality metric associated with wireless communications between the UE and the secondary cell;
receive a secondary cell activation message associated with the secondary cell; and
determine, in response to receiving the secondary cell activation message, whether the timing advance value determined prior to receipt of the secondary cell de-activation message is valid for the wireless communications between the UE and the secondary cell after receipt of the secondary cell activation message based at least in part on a difference between the first signal quality metric and a second signal quality metric, wherein the second signal quality metric is determined after receipt of the secondary cell activation message.

2. The UE of claim 1, wherein, to determine whether the timing advance value is valid for the wireless communications between the UE and the secondary cell after receipt of the secondary cell activation message, the one or more processors are individually or collectively further operable to execute the code to cause the UE to:
determine that the difference between the first signal quality metric and the second signal quality metric is less than or equal to a threshold, the one or more processors are individually or collectively further operable to execute the code to cause the UE to:
reuse the timing advance value based at least in part on the difference satisfying the threshold.

3. The UE of claim 2, wherein the one or more processors are individually or collectively further operable to execute the code to cause the UE to:
receive control signaling that indicates the threshold.

4. The UE of claim 1, wherein the one or more processors are individually or collectively further operable to execute the code to cause the UE to:
receive control signaling that indicates a first duration of time associated with a determination of the first signal quality metric.

5. The UE of claim 4, wherein the one or more processors are individually or collectively further operable to execute the code to cause the UE to:
determine the timing advance value at a first time; and
determine the first signal quality metric within a first time window based at least in part on the first duration and the first time.

6. The UE of claim 4, wherein the first duration is based in part on a measurement cycle of the secondary cell, a frequency range, a scaling factor or a combination thereof.

7. The UE of claim 1, wherein the one or more processors are individually or collectively further operable to execute the code to cause the UE to:
receive control signaling that indicates a second duration associated with a determination of the second signal quality metric.

8. The UE of claim 7, wherein the one or more processors are individually or collectively further operable to execute the code to cause the UE to:
determine the second signal quality metric within a second time window based at least in part on the second duration and a time for which validity of the timing advance value is evaluated.

9. The UE of claim 7, wherein the second duration is based in part on a measurement cycle of the secondary cell, a frequency range, a scaling factor or a combination thereof.

10. The UE of claim 1, wherein the first signal quality metric is determined based at least in part on a cell defining synchronization signal block, a non-cell defining synchronization signal block, a tracking reference signal or a channel state information reference signal.

11. The UE of claim 1, wherein, to determine whether the timing advance value is valid for the wireless communications between the UE and the secondary cell after receipt of the secondary cell activation message, the one or more processors are individually or collectively further operable to execute the code to cause the UE to:
determine that the difference between the first signal quality metric and the second signal quality metric is greater than a threshold, the one or more processors are individually or collectively further operable to execute the code to cause the UE to:
suspend an uplink transmission on a first timing advance group (TAG) associated with the secondary cell,
discard the timing advance value associated with the first TAG; and
transmit, to a network entity, first control signaling that requests the network entity to issue an order for a random access procedure to acquire a second timing advance value associated with the first TAG.

12. The UE of claim 11, wherein the control signaling that requests the network entity to issue the order for the random access procedure is transmitted on an activated primary cell or a second secondary cell associated with a second TAG and the second secondary cell has a valid timing advance value, and the one or more processors are individually or collectively further operable to execute the code to cause the UE to:
receive second control signaling that indicates the order for the random access procedure; and
initiate the random access procedure on the activated primary cell or the secondary cell associated with the first TAG.

13. The UE of claim 1, wherein the first signal quality metric and the second signal quality metric are determined based at least in part on a same type of downlink reference signal or a different type of downlink reference signal.

14. The UE of claim 1, wherein the first signal quality metric and the second signal quality metric are determined on different cells having a same timing advance group as the secondary cell.

15. The UE of claim 1, wherein:
the secondary cell is configured with physical uplink control channel resources.

16. The UE of claim 1, wherein the first signal quality metric and the second signal quality metric are both reference signal received power (RSRP) determinations.

17. The UE of claim 1, wherein the UE is in a radio resource control (RRC) connected mode during the determination the timing advance value and during the determination of the first signal quality metric.

18. A network entity, comprising:
one or more memories storing processor-executable code; and
one or more processors coupled with the one or more memories and individually or collectively operable to execute the code to cause the network entity to:
transmit, to a user equipment (UE), a first control signaling that indicates a threshold associated with determining that a timing advance value is valid;
transmit, to the UE and after transmission of the first control signaling, a secondary cell de-activation message associated with a secondary cell; and
transmit, to the UE, a secondary cell activation message associated with the secondary cell, wherein the secondary cell activation message is transmitted prior to a determination that the timing advance value is valid.

19. The network entity of claim 18, wherein the one or more processors are individually or collectively further operable to execute the code to cause the network entity to:
transmit, to the UE, control signaling that indicates a first duration of time associated with a determination of a first signal quality metric at the UE, wherein the determination of the first signal quality metric is prior to transmission of the secondary cell de-activation message.

20. The network entity of claim 19, wherein the first duration is based in part on a measurement cycle of the secondary cell, a frequency range, a scaling factor or a combination thereof.

21. The network entity of claim 18, wherein the one or more processors are individually or collectively further operable to execute the code to cause the network entity to:
transmit, to the UE, control signaling that indicates a second duration of time associated with a determination of a second signal quality metric at the UE, wherein the secondary cell activation message is transmitted prior to the determination of the second signal quality metric.

22. The network entity of claim 21, wherein the second duration is based in part on a measurement cycle of the secondary cell, a frequency range, a scaling factor or a combination thereof.

23. The network entity of claim 18, wherein:
the secondary cell is configured with physical uplink control channel resources.

24. A method for wireless communication by user equipment (UE), comprising:
receiving a secondary cell de-activation message associated with a secondary cell, the secondary cell de-activation message received after determination by the UE of a timing advance value for an uplink transmission to the secondary cell and after determination of a first signal quality metric associated with wireless communications between the UE and the secondary cell;
receiving a secondary cell activation message associated with the secondary cell; and
determining, in response to receiving the secondary cell activation message, whether the timing advance value determined prior to receipt of the secondary cell de-activation message is valid for the wireless communications between the UE and the secondary cell after receipt of the secondary cell activation message based at least in part on a difference between the first signal quality metric and a second signal quality metric, wherein the second signal quality metric is determined after receipt of the secondary cell activation message.

25. The method of claim 24, wherein determining whether the timing advance value is valid for the wireless communications between the UE and the secondary cell after receipt of the secondary cell activation message further comprises:
determining that the difference between the first signal quality metric and the second signal quality metric is less than or equal to a threshold, the method further comprising:
reusing the timing advance value based at least in part on the difference satisfying the threshold.

26. The method of claim 24, further comprising:
receiving control signaling that indicates a first duration of time associated with a determination of the first signal quality metric.

27. The method of claim 26, further comprising:
determining the timing advance value at a first time; and
determining the first signal quality metric within a first time window based at least in part on the first duration and the first time.

28. A method for wireless communication by network entity, comprising:
transmitting, to a user equipment (UE), a first control signaling that indicates a threshold associated with determining that a timing advance value is valid;
transmitting, to the UE and after transmission of the first control signaling, a secondary cell de-activation message associated with a secondary cell; and
transmitting, to the UE, a secondary cell activation message associated with the secondary cell, wherein the secondary cell activation message is transmitted prior to a determination that the timing advance value is valid.

29. The method of claim 28, further comprising:
transmitting, to the UE, control signaling that indicates a first duration of time associated with a determination of a first signal quality metric at the UE, wherein the determination of the first signal quality metric is prior to transmission of the secondary cell de-activation message.

30. The method of claim 28, further comprising:
transmitting, to the UE, control signaling that indicates a second duration of time associated with a determination of a second signal quality metric at the UE, wherein the secondary cell activation message is transmitted prior to the determination of the second signal quality metric.
